(19) United States
(12) Patent Application Publication
(10) Pub. No.: US 2001/0024272 A1
(43) Pub. Date: Sep. 27, 2001

(54) Method and apparatus for optical detection of deformations, particularly small bubbles, in optical data carriers

(76) Inventor: Dirk Luetjens, Ahrensburg (DE)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 09/775,675

(22) Filed: Apr. 19, 2001

(30) Foreign Application Priority Data
Feb. 5, 2000 (DE) 100 04 889.7

(51) Int. Cl. G01N 21/88

(52) U.S. Cl. 356/237.2

(57) ABSTRACT

The invention concerns a method and a device for optical detection of defects, like local deformations or bubbles, in an object, especially an optical data carrier, wherein the object is illuminated with light by at least one light source and the light reflected by or transmitted through the object is received by at least one light-sensitive receiver, in which, in a defect-free object, the light is reflected by or transmitted through the object at a normal angle of reflection along a normal axis of reflection. According to the invention, it is proposed that in front of the light-sensitive receiver, at least one property of at least one part of the light incident on the receiver is varied when the light is reflected by or transmitted through the object along an axis of reflection shifted from the normal axis of reflection and/or with an angle of reflection shifted from the normal angle of reflection.

### DESCRIPTION

The invention concerns a method and device for optical detection of defects, like local deformations, inclusions or bubbles, in an object, especially an optical data carrier. In the method, the object is illuminated with light by at least one light source and the light reflected by or transmitted through the object is recorded by at least one light-sensitive receiver. In an object free of defects, the light is reflected by or transmitted through the object at a normal reflection angle along a normal axis of reflection.

Such an optical test method for inspection of optical data carriers, like CDs, CD-ROMs, DVDs or CD-Rs, is known, for example, from DE-OS 44 34 474. Here, the data carrier is illuminated by a linear light beam. Any deformations are recognized by the profile of the line imaged on a matrix-like sensor. It is also known from DE-PS 197 31 545 to detect deformations of a surface by illuminating the surface with a number of discrete light-emitting diodes and then recognizing the deformations by shifts in the light spots imaged on the matrix-like sensor. With these methods or devices, however, only large-area deformations and gradients of the entire surface can be detected.

In the wake of increasingly larger data density in such optical data carriers, smaller defects can also lead to incorrect readout of the data carrier. An optical data carrier is generally constructed from layers of transparent and metallized or partially metallized layers. Bubbles can be present in one of the layers or between layers. Such bubbles do not cause significant readout errors, but these bubbles represent air inclusions that lead to long-term damage of the data carrier, especially corrosion of the metallic mirror layer or partially transparent mirror layer. Ordinary inspection systems are not always capable of detecting low-contrast inclusions. Detection of such defects, however, is essential, since these can often be traced back to a system error in the production line and thus, these defects are present in almost all data carriers produced on this line. Early recognition of these errors is therefore desirable for rapid intervention in the production process.

The underlying task of the invention is to design a method and device of the type described above so that detection of local deformations, inclusions, and bubbles is possible.

The task is solved according to the invention in that at least one property of at least one part of the light is changed before the light is incident on the light-sensitive receiver when the light is reflected by or transmitted through the object along an axis of reflection shifted from the normal axis of reflection and/or with a reflection angle deviating from the normal reflection angle. Because of this, a situation is achieved in which even a small local deformation and a slight change in direction or profile of the light coming from the object leads to a change in the light itself. Thus, improved detection, imaging and subsequent evaluation are possible.

Which properties of the light incident on the light-sensitive receiver to be altered is arbitrary, in principle. It can be prescribed that the light incident on the light-sensitive receiver be altered in intensity, its intensity profile across the light-sensitive receiver, and/or polarization and/or that a wavelength or wavelength range be filtered out. In the following, incident intensity should be understood to also refer to a change in any light property.

For this purpose optical devices can be used that give the incident light a profile according to the corresponding property, in particular intensity, by means of the light-sensitive receiver. The property profile has a detectable gradient or local maximum or minimum that shifts as a function of the angle of incidence or axis of incidence on the optical device relative to the light-sensitive receiver. The gradient or local maximum or minimum changes over the light-sensitive receiver so that the shift in profile leads to a correspondingly altered, in particular brighter or darker, image. Deformations can be recognized by means of a beam or beams that have been reflected differently.

The change can occur continuously as a function of the degree of deviation and, for example, become stronger with increasing deviation. An almost abrupt change, for example, also stepwise, can also be expedient. In principle, it is advantageous if the intensity, i.e., the brightness, of the incident light is varied. Detection of the change in brightness is easily possible and a representation of the local deformation or bubble can be produced in a corresponding display device.

It can be prescribed to reduce the intensity of the incident light when the light is reflected or transmitted at an angle of reflection shifted towards one direction and/or along an axis of reflection shifted in this direction and to increase the intensity of the incident light when the light is reflected or transmitted at an angle of reflection shifted towards the other direction and/or along an axis of reflection shifted in this other direction. This means that when the angle is shifted towards one direction, the image of the test object becomes darker and in the other, preferably opposite direction, it becomes brighter. As a limiting case, it can be expedient if the incident light is largely masked when the light is reflected or transmitted at an angle of reflection shifted towards one direction and/or along an axis of reflection shifted in this one direction and if the incident light is largely transmitted to the light-sensitive receiver when the light is reflected or transmitted at an angle of reflection shifted towards the other direction and/or along an axis of reflection shifted in this other direction. This change can be achieved by a mask and its corresponding positioning in the beam path.

In principle, it is naturally also possible to reduce the intensity of the incident light or mask the light when the light is reflected or transmitted at an angle of reflection shifted in any direction and/or along an axis of reflection shifted in any direction. Alternatively, it can be prescribed to increase the intensity of the incident light when the light is reflected or transmitted at an angle of reflection shifted in any direction or along an axis of reflection shifted in any direction.

An optical data carrier is generally scanned linearly. For this purpose, at least the data region is illuminated with a linear light beam and the reflected or transmitted light illuminates a linear sensor of the light-sensitive receiver. It can be prescribed here that the changes of the incident light due to a shift in one direction occur perpendicular to the extent of the linear sensor.

It can be prescribed to illuminate the object with at least one essentially parallel light beam. The width of the light beam incident on the object can then be larger than the width of the optically active region of the light-sensitive sensor. The reflected or transmitted light can be focused in the objective of the light-sensitive receiver essentially independently of the angle of reflection and/or the axis of reflection. The change in property of the incident light can occur in principle at any point after reflection or transmission from the object being tested. In principle, it is expedient if the change is produced at a point where there is a large absolute shift of the light beam, especially between focusing and the objective of the light-sensitive receiver.

The method according to the invention is supposed to permit detection of local deformations in particular. It is obvious that the method is also sensitive to deformations with larger areas that have sloped surfaces. Here a change in the light on the entire light-sensitive receiver would have an effect, for example, on its linear chip. The overall image of the scanned region would therefore be darker or lighter. It can be proposed here that, if the object is illuminated with a light strip and the reflected or transmitted light strip illuminates a linear, optically active sensor of the light-sensitive receiver, when at least one property of the incident light changes over the entire or almost the entire length of the linear sensor of the light-sensitive receiver, the change is readjusted. Because of this, changes only based on large-area deformations can be equalized. This has the advantage that a uniformly bright image of the object is obtained. Readjustment can occur, for example, by changing the exposure time.

The device according to the invention for optical recognition of local defects, like local deformations, inclusions or bubbles, in an object, especially an optical data carrier, is provided with at least one light source that illuminates the object with light from one side and with at least one light-sensitive receiver that receives the light reflected by or transmitted through the object, in which in a defect-free data carrier, the light is reflected or transmitted from the object at a normal angle of reflection or along a normal axis of reflection. At least one optical means is provided in a device according to the invention in front of the light-sensitive receiver, through which at least one property and/or intensity of at least part of the light incident on the light-sensitive receiver is changed when the reflected or transmitted light is incident on the optical means at an angle of incidence shifted from the normal angle of incidence corresponding to the normal angle of reflection and/or along an axis of incidence shifted from the normal axis of incidence corresponding to the normal axis of reflection. The optical means can cause a continuous or almost instantaneous change in incident light as a function of the shift.

The light-sensitive receiver can have at least one linear, optically active sensor and the optical means can cause a change in the incident light during a shifted towards a direction perpendicular to the extent of the linear sensor. This design and layout are expedient for the scanning of generally circular data carriers in the radial direction over the radius or diameter.

A continuous change in the light can be produced, for example, by an optical means that has a transmission profile that varies as a function of angle of incidence and/or axis of incidence of the light on the optical means. Starting from the normal angle of incidence and the normal axis of incidence, the transmission profile can decrease in one direction when the light is incident at an angle of incidence and/or an axis of incidence shifted in this direction and it can increase in the other direction when the light is incident at an angle of incidence and/or axis of incidence shifted in this other direction. Such an optical means can have tinting that gets darker in a direction perpendicular to the linear sensor of the light-sensitive receiver. This optical means extends in front of or across the objective of the light-sensitive receiver and the tinting gets darker from one to the other side of the objective. This achieves a situation in which, when the light shifts in one direction, the brightness increases and when the light shifts in the other direction, the brightness decreases. Larger shifts therefore lead to even darker or even brighter images.

A continuous change can also be produced by an optical means having a transmission profile, which, starting from the normal angle of incidence and normal axis of incidence, produces a decreasing or increasing transmission when the light is incident on the light-sensitive receiver at a shifted angle of incidence and/or at a shifted axis of incidence. This transmission profile can be produced by an optical means with both a diminishing tinting in one direction and a darkening tinting in the opposite direction perpendicular to the linear sensor of the light-sensitive receiver. The optical means extends across the entire objective of the light-sensitive receiver and the line with minimum or maximum tinting is arranged parallel to the linear sensor of the light-sensitive receiver.

The optical means can also be designed as a mask, which, starting from the normal axis of incidence and normal angle of incidence, covers one side of the light-sensitive receiver so that the light at an angle of incidence and/or axis of incidence shifted in this direction is blocked, whereas light shifted in the other direction is transmitted. On this account, the desired change in intensity of the incident light is produced with a simple means. An intensity profile is produced with a relatively large gradient perpendicular to the mask edge from minimum to maximum intensity. The mask is then aligned parallel to the linear sensor of the light-sensitive receiver so that the preferably maximum gradient of the profile is just above the linear sensor. This achieves a situation in which the light that is reflected by or transmitted through a defect-free object causes average illumination of the light-sensitive receiver. Light deflected in the direction toward the nontransparent part of the mask causes a shift of the profile so that light with lower or also minimum intensity illuminates the light-sensitive receiver. This produces a darker image. In the other direction, light deflected onto the light transmitting part of the mask causes an opposite shift of the profile and produces a stronger illumination of the light-sensitive receiver.

The optical means can also be a slit mask whose slit is arranged parallel to the linear sensor of the light sensitive receiver. It is also possible for the optical means to comprise a strip-like mask whose nontransparent strip is aligned parallel to the linear optical sensor of the light-sensitive receiver. These masks generate local maximums or minimums of the intensity profile above the light-sensitive receiver. A shift in this profile due to deflected light causes the light-sensitive receiver to be illuminated either more weakly or more strongly.

The change to the incident light by changing the light intensity by attenuating or masking out part of the reflected or transmitted light from the beam path was described above. However, in principle, the optical means can also be designed as a color filter, polarization filter or similar filter which, starting from the normal axis of incidence and normal angle of incidence, covers one side of the light-sensitive receiver so that one wavelength or one wavelength range is filtered out or polarized from the light with an angle of incidence and/or axis of incidence shifted in this direction, whereas light shifted in the other direction is transmitted or, alternatively, filtered or polarized. By the appropriate design of such an optical element, a corresponding property profile can be produced over the light-sensitive receiver. The profile is shifted due to varied light incidence so that a change is detected.

It is obvious that bubbles, among other things, can be easily detected with such an arrangement. In particular, this arrangement will be suitable for a combination of inspection methods or steps in which the object is optically scanned by means of a telecentric structure or a slightly divergent structure. The light incident on the object is then a quasi-parallel light beam. The width of the light beam incident on the object can then be greater than the optically active width of the sensor of the light-sensitive receiver. The object is arranged in the parallel beam path of the telecentric structure. An optical lens arrangement, an achromatic lens, is then provided in front of the light-sensitive receiver, which focuses the incident light essentially independently of the angle of incidence and axis of incidence into the objective of the light-sensitive receiver. In principle, this has the advantage that without an optical means of the aforementioned type, optical scanning of the object is essentially insensitive to changes in beam direction and deformations as long as the shifts are within the tolerance range of the achromatic lens. This is generally the case during inspection of data carriers, since larger shifts lead to rejection anyway. The telecentric structure is especially expedient for detection of other defects.

However, the telecentric structure in principle stands in the way of detecting small and very small local geometric deformations. Only by arranging the optical means according to the invention in front of the light-sensitive receiver can the deformations also be recognized in a telecentric structure. It is expedient here if the reflected light beam is divided in order to illuminate two light-sensitive receivers, wherein such an optical means is provided only in front of one receiver.

The invention is further explained below with reference to the schematic drawing. Shown are:

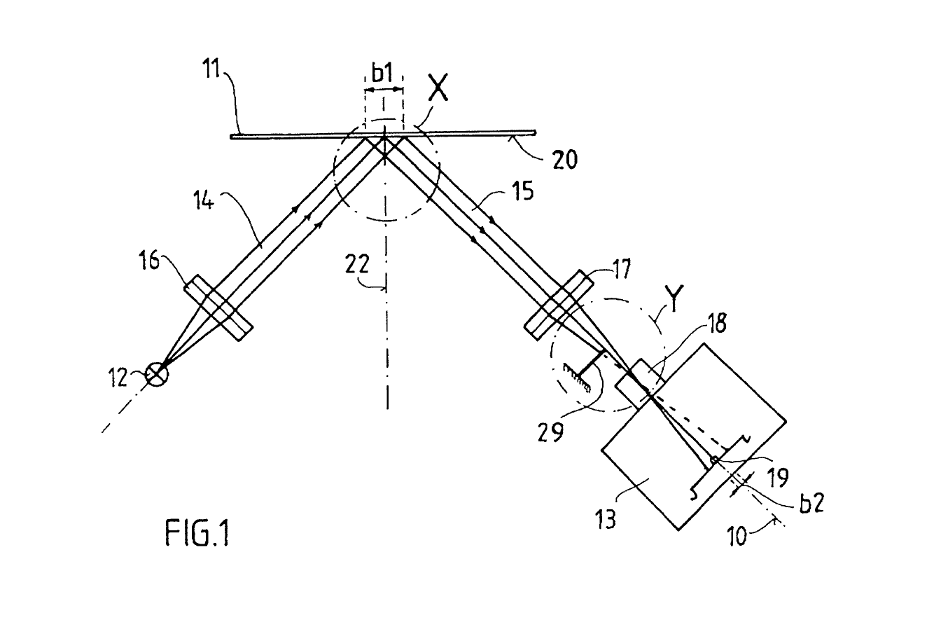

FIG. 1, a view of the test device according to the invention,

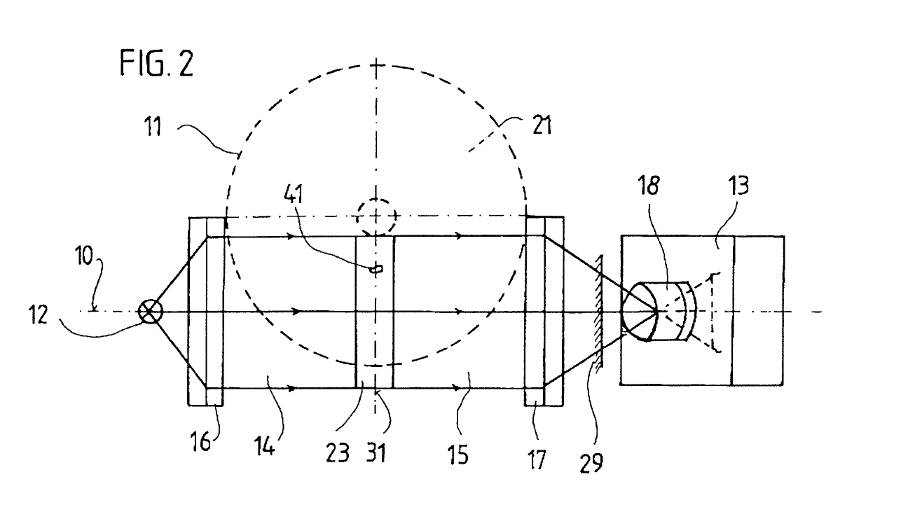

FIG. 2, a top view of the test device according to FIG. 1,

FIG. 3, an enlarged view of detail X in FIG. 1

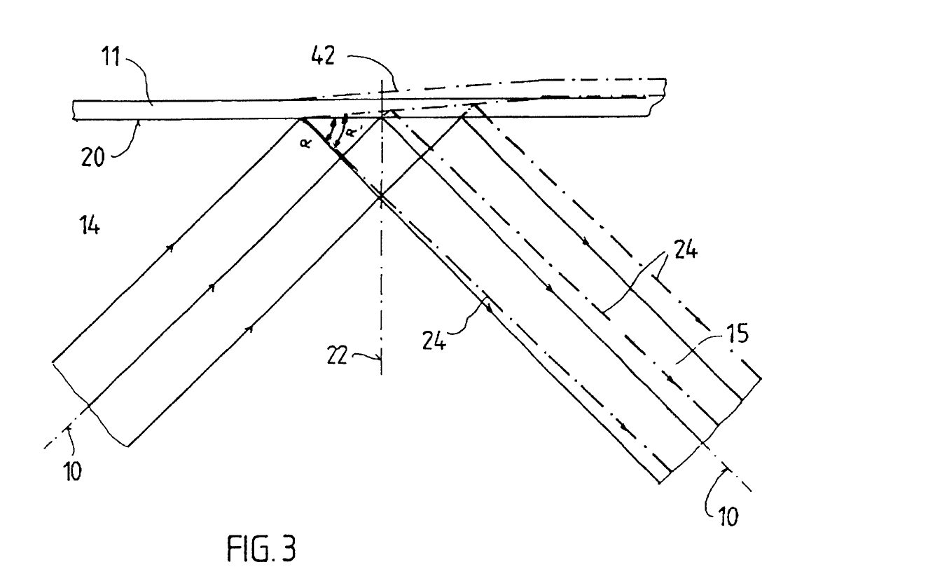

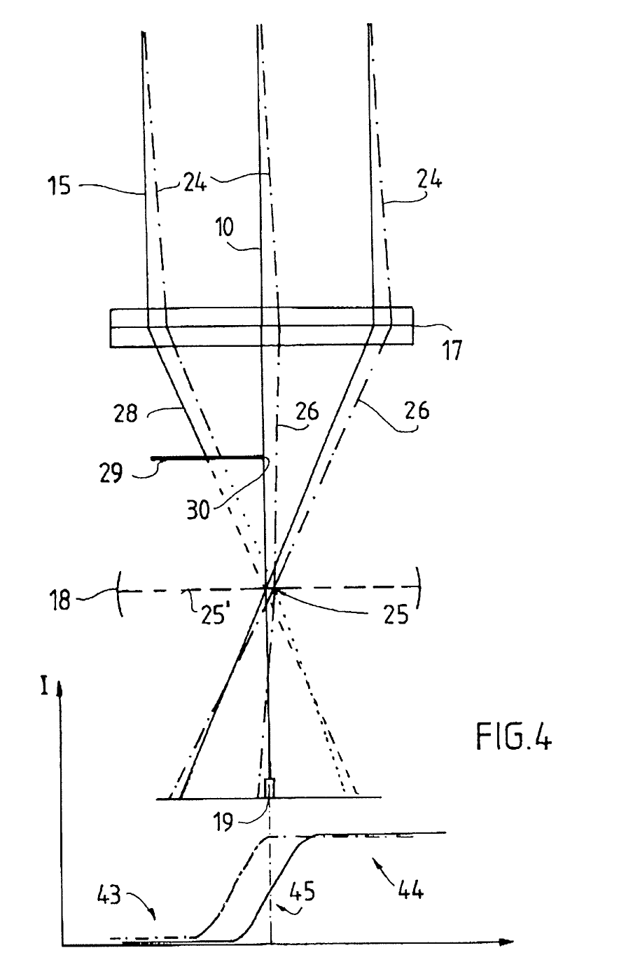

FIG. 4, an enlarged view of detail Y in FIG. 1

FIG. 5, detail Y during deflection of the light in another direction,

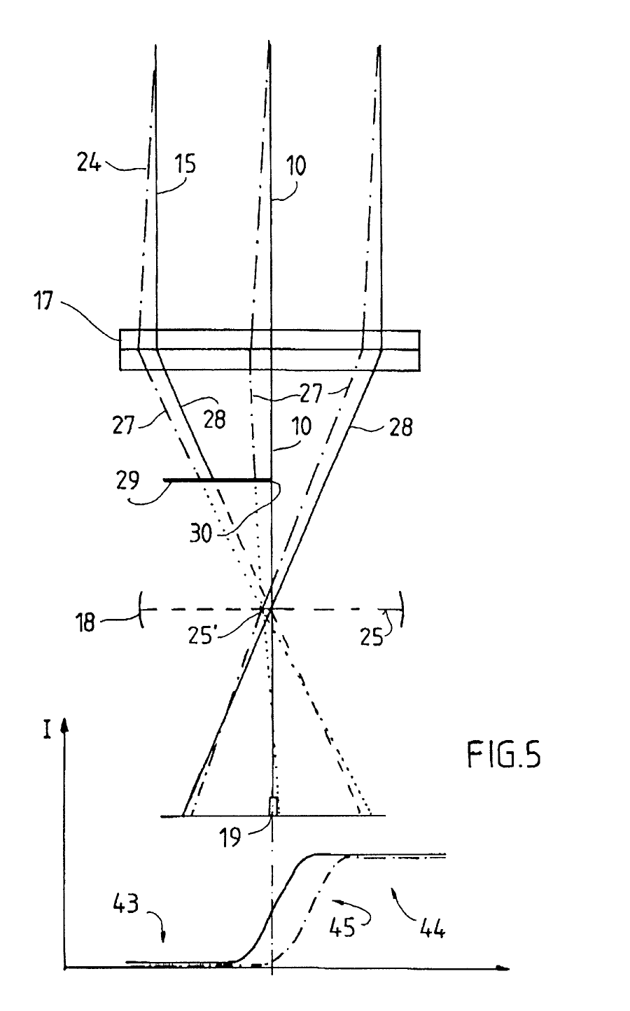

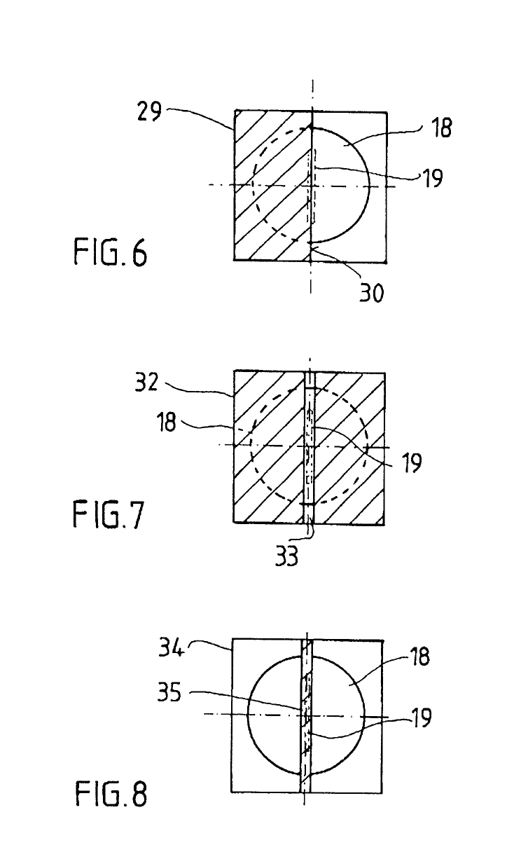

FIG. 6, a top view of the objective of the light-sensitive receiver with a mask,

FIG. 7, a top view of the objective of the light-sensitive receiver with a mask according to another embodiment,

FIG. 8, a top view of the objective of the light-sensitive receiver with a mask according to another embodiment,

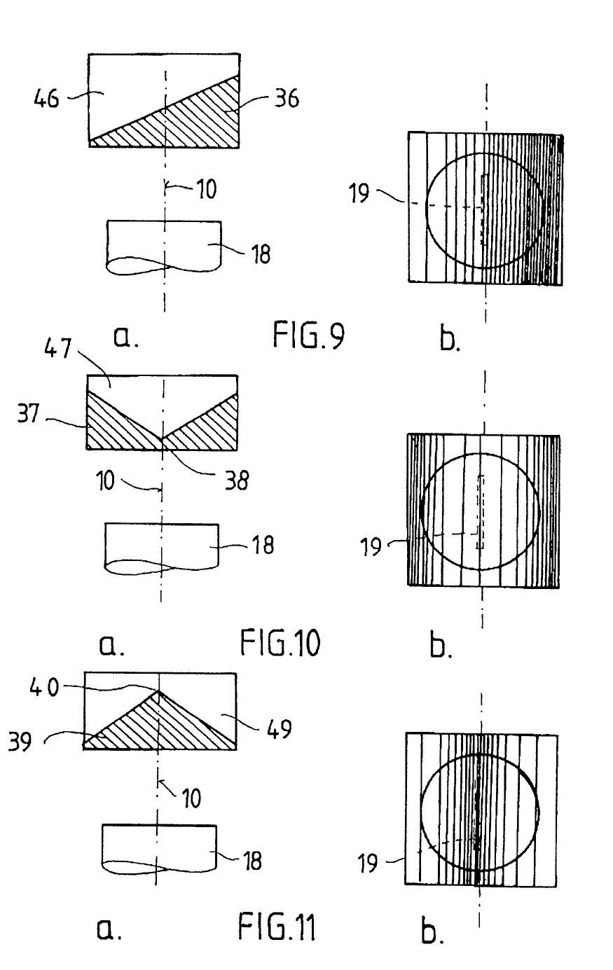

FIG. 9a, b, a side view and top view of the objective of the light-sensitive receiver and an optical means with a continuous transmission profile,

FIG. 10a, b, a side view and top view of the objective of the light-sensitive receiver and an optical means with a continuous transmission profile according to another embodiment,

FIG. 11a, b, a side view and top view of the objective of the light-sensitive receiver and an optical means with a continuous transmission profile according to another embodiment,

FIG. 12, the intensity profile over the width of the light-sensitive receiver, which is produced by the masks according to FIGS. 6 to 8, and

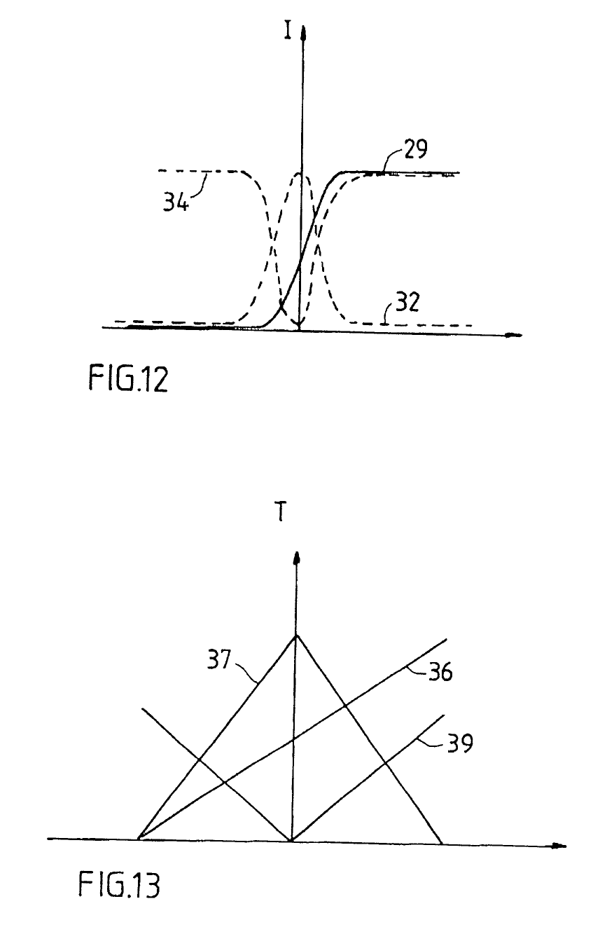

FIG. 13, the transmission profile over the width of the light-sensitive receiver produced by the optical means according to FIGS. 9 to 11.

The device represented in the drawing for optical testing of flat objects, especially circular data carriers 11, like CDs, CD-Rs, DVDs or the like, has a light source 12 to illuminate the data carrier and the light-sensitive receiver 13. The sensor 19 of the light-sensitive receiver is illuminated by the light reflected by the object. In principle, transparent objects can also be tested using a transmitted light method. The light source and the light sensitive receiver are then positioned on opposite sides of the object.

The light illuminates the data carrier linearly in the radial direction over the radial extent of data region 21. The data carrier is rotated at least once around its axis of rotation 22 so that at least the entire data region can be recorded. The light-sensitive receiver 13 is designed as a linear-array camera with a linear light-sensitive sensor 19. Sensor 19 is aligned with its longitudinal extent parallel to the center radial light line 31. In this respect, the represented structure corresponds to an ordinary device for optical scanning of data carriers and requires no further explanation here.

A telecentric structure is prescribed in the light beam path 14, 15 along the optical axis 10 between light source 12 and light-sensitive receiver 13 and includes at least one optical lens arrangement 16 in the beam direction behind the light source 12 and at least one optical lens arrangement 17 in front of the light-sensitive receiver 13. A parallel light beam 14 is generated by the lens arrangement 16 (condenser) from the light emitted by the light source, which, in a defect-free object 11, is reflected as a parallel light beam 15 along the optical axis 10 of the entire structure. It is pointed out here that a parallel light beam essentially refers to a parallel or quasi-parallel light beam according to physical possibilities. The light source preferably emits a white or colored light at different wavelengths. The light source, for example, can be a halogen lamp that emits divergent light.

The parallel light beam is bundled by the lens arrangement 17 (achromatic lens) in the objective 18 of the light-sensitive receiver and illuminates the light-sensitive sensor 19. The optical arrangement in terms of the selected focal width is such that the surface of the object is sharply focused on the light-sensitive sensor.

In the embodiment represented in the drawing, the object is illuminated by a strip-like light beam 23 of finite width b1, wherein the tangential width b1 incident on the object is greater than the corresponding width b2 of light-sensitive sensor 19. Because of this and the telecentric structure, a situation is achieved in which the optical scanning is essentially independent of a change in beam direction. Local and small deformations or height defects cause small changes in the reflected light beam even within the tolerance range of achromatic lens 17 so that a point on the object is always sharply focused on the sensor 19 of light-sensitive receiver 13 by this structure. It can be prescribed that especially for scanning of optical data carriers, the tangential width b1 is 1.0 to 20.0 mm, preferably 7.5 to 12.5 mm and the length is approximately equal to or greater than the radial width of the data region. Thus, 30.0-50.0 mm can be expedient. It can be prescribed that the extent of the incident light beam is larger than that of a defect that is detectable by the arrangement.

The parallel light beam 14 is reflected by a flat object 11 in a parallel light beam 15 at a normal angle of reflection α along a normal axis of reflection. The represented reflected light beams 15 run parallel to the optical axis 10 of the optical arrangement. As can be seen in particular in FIG. 3, if the object has a deformation 42, the light beams incident on the object are no longer reflected in this manner but at a reflection angle α′ that is at least shifted from the normal angle of reflection. In principle, as an alternative or in addition, parallel shifts of the reflected beam profile are also conceivable. A shifting of the entire reflected beam is shown in the drawing for explanation. The beams 24 reflected in a shifted fashion are shown in the drawing with a dash-dot line.

In the subsequent course of the telecentric structure, these shifted or pivoted beams 24 arrive at a different angle of incidence and/or a different axis of incidence on the second optical lens arrangement 17 as beams 15. Because of the optical tolerance range of this lens arrangement, these beams 24 are also focused at a focal point 25′ in the focal plane 25 of objective 18 of the light-sensitive receiver. The beams 15 that are incident on the lens arrangement 17 at the normal angle of reflection along the normal axis of reflection are also focused in this focal plane. Sharp images of part of the illuminated region of the object are produced on the linear light-sensitive sensor 19.

However, the shifted beams, starting from a center optical axis 10, reach the focal point 25′ in a shifted or pivoted direction. These beam profiles 26 and 27 are shown enlarged in FIGS. 4 and 5, and the shifted beams are also represented here with dash-dot lines.

This shifted beam profile is used in order to better detect local deformations with the light-sensitive receiver. Optical means 29, 32, 34, 36, 37, 39 are provided, which vary the properties, especially the intensity, acting on the light-sensitive receiver as a function of the profile of the reflected light beams. In a first embodiment, the optical means comprises mask 29, which is arranged in a light beam path between the optical lens arrangement 17 and the objective 18 of the light-sensitive receiver. The mask edge 30 is aligned parallel to the linear sensor 19 of the light-sensitive receiver 13.

The mask 29 causes distribution of the intensity of the incident light over sensor 19. The generated intensity profile is shown in FIGS. 4 and 5 in a diagram beneath sensor 19. A region 43 of smaller or minimum intensity and a region 44 of higher or maximum intensity are present. In-between, the intensity distribution has a transitional region (gradient) 45 which extends over a finite width perpendicular to the linear sensor 19. The mask is positioned here so that this transitional region 45 is located above the light-sensitive sensor, if a defect-free object has reflected the light beams. A normally bright image is produced, since an average intensity illuminates the light-sensitive receiver.

As shown in FIG. 4, during a deviation the focused light beams 26 of the reflected beams 24 assume a different profile than the normally focused beams 28 in the direction toward the focal point 25′ in focal plane 25 of the objective. The shifted beams run so that the intensity profile is shifted so that now the region 43 of higher intensity lies above the light-sensitive receiver. The shifted profile is shown with a dash-dot line. The image becomes brighter.

The shifting of the light beams in an opposite direction is shown in FIG. 5. The focused light beams 27 generate an intensity profile that is shifted relative to the normal intensity profile so that the region of lower intensity 44 lies above the sensor. The image becomes darker.

In principle, depending on the beam profile, a change in the intensity profile can also be produced in addition to a shift. In the interest of clarity, only a shift of the profile due to shifted light beams is shown in the drawing.

By this alignment of the mask edge, a situation can be achieved in which a detectable change in brightness of the image is produced when the reflected light beams are shifted in one direction and in the other direction. In principle, however, the mask can also be positioned differently so that only changes in one direction are detected.

Other masks that cause a change in the light intensity acting on the light-sensitive sensor when the reflected light is shifted are shown in a top view in FIGS. 7 and 8. The mask 32 according to FIG. 7 is designed as a slit mask. The transparent slit 33 is arranged parallel to the light-sensitive sensor 19. The corresponding intensity profile exhibits a local maximum above the light-sensitive sensor 19. Here the incident light is reduced when it is shifted both in one direction and the other direction perpendicular to the linear sensor 19. The mask 34 according to FIG. 8 is designed strip-like. The nontransparent strips 35 are aligned parallel to light-sensitive sensor 19. The corresponding intensity profile exhibits a local minimum above light-sensitive sensor 19. Here the incident light is increased when it is shifted both in one direction and the other direction perpendicular to linear sensor 19.

The intensity profiles that are produced by masks 29, 32 and 34 perpendicular to the light-sensitive sensor are shown in FIG. 12. According to shifted incident light, these profiles are shifted to the left or right so that a detectable change in brightness is produced. It is obvious that the change in brightness no longer increases after a certain amount of shift is surpassed.

Additional optical means are shown in FIGS. 9 to 11 that cause a change in the light incident on the light-sensitive sensor as a function of angle of incidence or type of incidence of the reflected light on the optical means. The optical means according to FIG. 9 has a wedge-like prism 36 which consists of a tinted material. A corresponding clear prism 46 that otherwise has the same optical properties is arranged above it for uniform light passage. The prism is arranged above the objective 18 of the light-sensitive receiver. The optical axis 10 runs approximately through the center of prism 36. The profile of increasing thickness of the prism is then aligned perpendicular to the linear sensor 19. This achieves a situation in which the light experiences a stronger attenuation with increasing deviation in one direction, which is to the right in FIG. 9. With increasing shifts in the other direction, the light experiences a continuously diminishing attenuation.

FIG. 10 shows a tinted prism 37 having a center region 38 with minimum thickness. Here again, a corresponding clear prism 47 is provided in order to create uniform light passage. The region of minimum thickness is aligned parallel to sensor 19. With this arrangement, a situation is achieved in which the light experiences a stronger attenuation with increasing amounts of shifts, regardless of the direction of the shift. FIG. 11 shows a prism 39 with the opposite effect. Here the center region 40 with maximum thickness is situated parallel to sensor 19. Here again, a corresponding clear prism 49 is provided in order to create uniform light passage. With increasing shifts, the incident light experiences a diminishing attenuation regardless of direction.

The prisms 36, 37, 39 preferably consist of a material with uniform tinting so that darker tinting is produced for increasing thickness. In principle, filters can also be provided that have tinting that varies perpendicular to sensor 19 in at least one direction. This varying tinting can be produced by photolithography or printing techniques. The varying tinting need not be linear either.

The transmission profiles over the width of the light-sensitive receiver are shown in FIG. 13, which are produced by optical prisms 36, 37 and 39. The ordinate corresponds to the optical axis 10 and the transmission profiles are marked with the reference numbers of the prisms. With increasingly shifted light beams, i.e., a larger difference angle with the normal angle of incidence or increasing distance from the optical axis, the degree of transmission becomes larger or smaller and the intensity of the incident light continuously increases or diminishes.

Another change of the incident light can be achieved by optical prisms in the light beam path that cause total reflection or refraction in another direction for light beams shifted from the normal angle of incidence. Here again, a shifted intensity profile that is detectable based on the shift is established.

The change in light incident on sensor 19 is set independently of the extent of the deformation on the scanned surface of the object. Deformations that extend over the entire radius of the object also lead to a change in the light. It is prescribed to readjust the change of the incident light if this occurs along the entire or at least nearly the entire sensor. The sensor 19 in principle has a number of light-sensitive pixels that are arranged along a line. A specific region or radius of the object is assigned to each pixel. If there is a large-area deformation in the object, the resulting change in light has an effect on all pixels of the sensor. This can be recognized immediately by calculation and compensated. A uniformly bright image of the object can therefore be obtained.

For small and local deformations 41 that have only surface extent, only one or a limited number of pixels are affected by the change in incident light. This local deformation can be recognized immediately by pixel-by-pixel readout and evaluation. The readjustment of the produced change can then be performed if a predetermined number of pixels detects the same change. The number of pixels can also be smaller than the total number of pixels of the sensor.

The structure and achieved effect were described above by means of a linear sensor of the light-sensitive receiver. Naturally, the light-sensitive receiver can also have a matrix-like receiver. Here the shift in generated profile is fully recorded and can be evaluated. In a matrix-like receiver, it is also possible to use only one or a predetermined number of pixels, for example, pixels in parallel lines or regions of the matrix, for evaluation.

1. Method for optical recognition of defects, like local deformations (41) or bubbles, in an object, especially an optical data carrier (11), in which method the object is illuminated with light by at least one source (12) and the light (15) reflected by or transmitted through the object is received by at least one light-sensitive receiver (13), in which the light is reflected by or transmitted through the object at a normal angle of reflection (α) along a normal axis of reflection (15) for a defect-free object, characterized by the fact that in front of the light-sensitive receiver, at least one property of at least one part of the light is varied when the light is reflected by or transmitted through the object along an axis of reflection (24) shifted from the normal axis of reflection and/or with an angle of reflection (α′) shifted from the normal angle of reflection.

2. Method according to claim 1, characterized by the fact that the light incident on the light-sensitive receiver is varied in intensity and/or polarization and/or at least one wavelength or wavelength range is filtered out.

3. Device according to claim 1 or 2, characterized by the fact that a property profile, especially an intensity profile, of the incident light is produced above the light-sensitive receiver with a gradient (45) or a local maximum or minimum when the light was reflected by or transmitted through the object (11) at the normal angle of reflection along the normal axis of reflection, in which the profile is shifted and/or changed as a function of the shift of the reflected or transmitted light relative to the light-sensitive receiver.

4. Method according to one of claims 1 to 3, characterized by the fact that the change occurs continuously or essentially instantly as a function of the shift.

5. Method according to one of claims 1 to 4, characterized by the fact that the intensity of the incident light is reduced when the light is reflected or transmitted at an angle of reflection shifted in one direction and/or along an axis of reflection shifted in this one direction and that the intensity of the incident light increases when the light is reflected or transmitted at an angle of reflection shifted in the other direction and/or along an axis of reflection shifted in this other direction.

6. Method according to one of claims 1 to 4, characterized by the fact that a large part of the incident light is blocked when the light is reflected or transmitted at an angle of reflection shifted in one direction and/or along an axis of reflection shifted in this one direction and that a large part of the incident light is transmitted to the light-sensitive receiver when the light is reflected or transmitted at an angle of reflection shifted in the other direction and/or along an axis of reflection shifted in this other direction.

7. Method according to one of claims 1 to 4, characterized by the fact that the intensity of the incident light is reduced when the light is reflected or transmitted at an angle of reflection shifted in any direction and/or an axis of reflection shifted in any direction.

8. Method according to one of claims 1 to 4, characterized by the fact that the intensity of the incident light increases when the light is reflected or transmitted at an angle of reflection shifted in any direction or along an axis of reflection shifted in any direction.

9. Method according to one of claims 1 to 8, characterized by the fact that the light-sensitive receiver has at least one linear, optically active sensor (19) and that the change of the incident light occurs perpendicular to the extent of the linear sensor during a shift in one direction.

10. Method according to one of claims 1 to 9, characterized by the fact that the object is illuminated by at least one essentially parallel light beam (14).

11. Method according to one of claims 1 to 10, characterized by the fact that the width (b1) of the light beam (14) incident on the object is larger than the optically active width (b2) of the light-sensitive sensor (19).

12. Method according to one of claims 1 to 11, characterized by the fact that the reflected or transmitted light is focused in the objective of the light-sensitive receiver essentially independently of the angle of reflection and/or axis of reflection.

13. Method according to one of claims 1 to 12, characterized by the fact that the change in property of the incident light occurs between focusing and the objective of the light-sensitive receiver.

14. Method according to one of claims 1 to 13, characterized by the fact that the object is illuminated by means of a light strip and the reflected or transmitted light strip illuminates a linear, optically active sensor of the light-sensitive receiver and that during a change in at least one property of the incident light over the entire or almost the entire length of the linear sensor of the light-sensitive receiver, the change is readjusted, especially compensated.

15. Device for optical detection of defects, like local deformations (41) or bubbles, in an object, especially an optical data carrier (11), with at least one light source that illuminates the object (11) with light and with at least one light-sensitive receiver (13) that receives the light reflected by or transmitted through the object, in which, for a defect-free data carrier the light is reflected by or transmitted through the object at a normal angle of reflection (a) or along a normal axis of reflection (15), characterized by the fact that at least one optical means (29, 32, 34, 36, 37, 39) is provided in front of the light-sensitive receiver (13), through which at least part of the light incident on the light-sensitive receiver is varied in at least one of its properties and/or intensity when the reflected or transmitted light is incident on the optical means at an angle of incidence (α′) shifted from the normal angle of incidence corresponding to the normal angle of reflection and/or along an axis of incidence (26, 27) shifted from the normal axis of incidence (28) corresponding to the normal axis of reflection.

16. Device according to claim 15, characterized by the fact that the light-sensitive receiver has at least one linear, optically active sensor (19) and that the optical means (29, 32, 34, 36, 37, 39) causes a change in the incident light when it is shifted in a direction perpendicular to the extent of the linear sensor (19).

17. Device according to claim 15 or 16, characterized by the fact that the optical means causes a continuous or almost instantaneous change of the incident light as a function of the shift.

18. Device according to one of claims 15 to 17, characterized by the fact that the optical means (36, 37, 39) has a transmission profile whose transmission varies as a function of the angle of incidence and/or axis of incidence of the light on the optical means.

19. Device according to one of claims 15 to 17, characterized by the fact that the optical means (36) has a transmission profile, which, starting from the normal angle of incidence and normal axis of incidence, decreases in one direction when the light has a shifted angle of incidence and/or axis of incidence in this direction and increases in the other direction when the light has a shifted angle of incidence and/or axis of incidence in the other direction.

20. Device according to one of claims 15 to 17, characterized by the fact that the optical means (39, 37) has a transmission profile, which, starting from the normal angle of incidence and the normal axis of incidence, decreases or increases when the light is incident on the light sensitive receiver at a shifted angle of incidence and/or a shifted axis of incidence.

21. Device according to one of claims 15 to 20, characterized by the fact that the optical means is designed as a mask (29), which, starting from the normal axis of incidence and the normal angle of incidence, covers one side of the light-sensitive receiver so that light with an angle of incidence and/or an axis of incidence shifted in this direction is blocked, whereas light shifted in the other direction is transmitted.

22. Device according to one of claims 15 to 21, characterized by the fact that the optical means is designed as a color filter or polarization filter, which, starting from a normal axis of incidence and a normal angle of incidence, covers one side of the light-sensitive receiver so that a wavelength or wavelength range is filtered out or polarized for light with a shifted angle of incidence and/or axis of incidence in this direction, whereas light shifted in the other direction is transmitted or, alternatively, filtered or polarized.

23. Device according to one of claims 14 to 22, characterized by the fact that the mask (29, 32, 34) is positioned parallel to the linear sensor (19) of the light-sensitive receiver (13).

24. Device according to one of the claims 15 to 23, characterized by the fact that the optical means (29, 32, 34) has a property profile, especially an intensity profile, for the incident light with a gradient (45) or a local maximum or minimum over the light-sensitive receiver when the light was reflected by or transmitted through the object (11) at the normal angle of reflection along the normal axis of reflection, in which the profile is shifted and/or changed as a function of the shift of the reflected or transmitted light relative to the light-sensitive receiver based on the optical means.

25. Device according to one of claims 15 to 24, characterized by the fact that the optical means is a slit mask (32) whose slit (33) is arranged parallel to the linear sensor (19) of the light-sensitive receiver.

26. Device according to one of claims 15 to 25, characterized by the fact that the optical means includes a linear mask (34) whose transparent strip (35) is aligned parallel to linear optical sensor (19) of the light-sensitive receiver.

27. Device according to one of claims 15 to 26, characterized by the fact that the optical means (36) has a darkening tinting in the direction perpendicular to the linear sensor of the light-sensitive receiver, in which the optical means extends at least partially over the objective of the light-sensitive receiver and the tinting darkens from one side to the other side of the objective.

28. Device according to one of claims 15 to 26, characterized by the fact that the optical means (39, 37) has brightening tinting in one direction and darkening tinting in the opposite direction perpendicular to the linear sensor of the light-sensitive receiver, in which the optical means extends at least partially over the objective of the light-sensitive receiver and the line with minimum or maximum tinting is arranged above the linear sensor of the light-sensitive receiver.

29. Device according to one of claims 15 to 28, characterized by the fact that the light is an essentially parallel light beam.

30. Device according to one of claims 15 to 29, characterized by the fact that the width (b1) of the light beam incident on the object is larger than the optically active width (b2) of the sensor of the light-sensitive receiver.

31. Device according to one of claims 15 to 30, characterized by the fact that an optical lens arrangement (17) is provided in front of the light-sensitive receiver, which focuses the incident light essentially independently of the angle of incidence and the axis of incidence in the objective of the light-sensitive receiver, the optical means being arranged between the optical lens arrangement and the objective to vary the properties of the incident light.

32. Device according to one of claims 15 to 31, characterized by a telecentric structure in which the object is arranged in the parallel beam path (14, 15) of the telecentric structure.
